(19) United States
(12) Patent Application Publication
(10) Pub. No.: US 2024/0276038 A1
(43) Pub. Date: Aug. 15, 2024

(54) Markydoo.net

(71) Applicant: Michael Allen, Baltimore, MD (US)

(72) Inventor: Michael Allen, Baltimore, MD (US)

(21) Appl. No.: 18/626,305

(22) Filed: Apr. 3, 2024

(51) Int. Cl. H04N 21/2387; G06F 21/10

(52) U.S. Cl. CPC H04N 21/2387; G06F 21/10

(57) ABSTRACT

Markydoo.net emerges as a trailblazer in the realm of online film streaming by becoming the inaugural platform legally authorized to stream films concurrently screening in theatres. Markydoo.net's innovative approach challenges traditional distribution models by granting audiences access to the latest cinematic releases from the comfort of their homes. Through strategic partnerships with major film studios and distributors, Markydoo.net secures the rights to showcase in-theatre films, offering viewers an unparalleled opportunity to experience blockbuster hits without delay. Leveraging cutting-edge encryption technologies and robust content protection measures, Markydoo.net ensures the secure transmission of exclusive content while safeguarding the intellectual property of filmmakers and rights holders. With a commitment to enhancing the accessibility and convenience of film viewing, Markydoo.net sets a new standard for cinematic entertainment, heralding a paradigm shift in the way audiences consume the latest box office sensations.

### 1. SUMMARY OF INVENTION

Markydoo.net is a video on demand (VOD) service that streams newly released (premiere) films that are still in theatres before they become available for home viewing. Markydoo.net also offers free unlimited access to film trailers, music, and podcasts while it charges monthly for access to TV series and pay-per-view screenings of in theatre films. Markydoo.net has a unique feature which allows users the ability to pause, resume rewind and fast-forward previous parts played in the film within the interval that the film is screened. Markydoo.net's source of film content is directly from film production companies and/or studios.

The advantage of markydoo is that it is the first video on demand website that streams films still in theatre. Markydoo has a simple user interface that allows users to browse freely and access it's exclusive content. Markydoo's content providers are independent artists and major studios. Markydoo is offering content providers and major studio's 100% revenue (or other negotiated percentage) accumulated from sales content while its revenue is gained through advertisements. Markydoo's subscription model is a paywall with three tiers: Basic, Standard and Premium. The basic tier is free whereas standard allows access to Pay-Per-View screenings of in theatre films and premium offers unlimited access to music, podcasts, TV shows and series.

### 2. DETAILED DESCRIPTION OF INVENTION

### Interactive Features

The film streaming website “Markydoo.net” offers a unique and interactive viewing experience for its users. Upon selecting a film to watch, users have the ability to pause, rewind, and replay the film within the interval that the film is currently streaming.

### 3. FEATURES OF MARKYDOO.NET

Interactive Viewing: Users can actively engage with the film by pausing it at any point during the stream. This feature allows users to take breaks, discuss scenes, or simply savor a particular moment.

Rewind Functionality: In case users miss a crucial part of the film or want to rewatch a scene, they can easily rewind to a specific point in the film. This feature enhances the viewing experience by providing flexibility in navigating through the content.

Replay Option: If a user wants to replay a particular scene or dialogue, they can do so within the interval of the streaming duration. This feature enables users to revisit their favorite moments or catch subtle details they may have missed initially.

Real-time Controls: The controls for pausing, rewinding, and replaying are seamlessly integrated into the streaming player, ensuring a smooth and intuitive user experience.

By incorporating these interactive features, Markydoo.net aims to elevate the traditional film-watching experience and empower users to engage with the content in a more personalized and immersive manner.

To demonstrate the interactive features of Markydoo.net, let's say Corneille is watching a suspenseful thriller on the platform. During a tense moment in the film, they decide to pause the film to discuss a plot twist with their friends.

After the discussion, Corneille uses the rewind functionality to revisit a crucial revelation they missed earlier. Satisfied with the clarity gained from the rewind, they continue watching but find a particular scene so captivating that they opt to replay it multiple times within the streaming interval.

Through these interactions, Corneille not only enjoys the film but also actively participates in shaping their viewing experience, thanks to the interactive features provided by Markydoo.net.

### 4. ADVERTISEMENT INTEGRATION IN STREAMING PLATFORM

Advertisements are played between short intervals while the film is playing. At the beginning, middle and end of the film.

In the streaming platform “Markydoo.net,” advertisements are strategically incorporated within short intervals while the film is playing to ensure a seamless viewing experience for users. Here are how the advertisements are played within the streaming intervals:

### 5. ADVERTISEMENT INTEGRATION PROCESS

Scheduled Ad Breaks: Markydoo.net schedules specific intervals during the film playback where advertisements can be inserted without causing disruption to the viewing experience. These intervals are strategically placed to maintain the flow of the film.

Non-intrusive Ad Format: The advertisements are displayed in a non-intrusive manner, such as a brief pre-roll ad before the film starts or short mid-roll ads during natural breaks in the content, like scene transitions or chapter changes.

Ad Duration Control: markydoo.net ensures that the duration of each advertisement is limited, typically ranging from a few seconds to a minute, to prevent viewers from feeling overwhelmed by excessive commercial interruptions.

User-Friendly Ad Placement: Advertisements are placed in a way that does not obstruct critical moments in the film or disrupt the narrative flow. This careful placement ensures that users can easily resume watching the film after each ad break.

Ad Relevance and Targeting: Markydoo.net leverages user data and preferences to deliver targeted advertisements that are relevant to the viewer's interests. By displaying personalized ads, markydoo.net aims to enhance user engagement and create a more tailored advertising experience.

By implementing these strategies, Markydoo.net strikes a balance between monetization through advertisements and preserving the quality of the viewing experience for its users.

### ###Example Scenario:

Imagine Corneille is watching an action-packed film on Markydoo.net. As the film approaches a climactic scene, a short advertisement break is seamlessly inserted during a natural pause in the action.

The advertisement, relevant to Corneille's interests, quickly plays, showcasing a promotion for a new action film release. Thanks to its non-intrusive nature and short duration, Corneille doesn't feel disconnected from the main film.

After the ad concludes, Corneille resumes watching the film without missing any crucial moments, maintaining the immersive viewing experience provided by Markydoo.net's well-integrated advertisement strategy.

Users may enjoy uninterrupted film-watching on Markydoo.net with thoughtfully integrated advertisements that enhance your viewing experience!

### 6. ENCRYPTION OF CONTENT

markydoo.net uses the following technological measures to prevent piracy:

Markydoo.net will use Digital Rights Management (DRM): DRM technologies will help protect copyrighted content by controlling how it is accessed, shared, and distributed. By encrypting the video files and requiring a valid decryption key for playback, DRM can prevent unauthorized copying and distribution of content.

Markydoo.net will practice Anti-piracy Monitoring: Utilizing sophisticated algorithms and digital tools, streaming websites can actively monitor for instances of piracy, such as illegal streaming websites or torrent platforms distributing copyrighted content. By detecting and taking action against such piracy channels, the website can reduce the unauthorized distribution of content.

Dynamic Watermarking: Dynamic watermarking involves embedding unique viewer-specific information within the video stream in real-time. This allows content owners to trace the source of a leak back to a specific user in case of unauthorized distribution.

Data Encryption: The video content itself is encrypted using algorithms like AES (Advanced Encryption Standard) before being transmitted over the network. This ensures that even if intercepted, the video data remains secure and cannot be viewed without the decryption key.

Digital Rights Management (DRM): To prevent unauthorized distribution and piracy, streaming websites often implement DRM technologies. These technologies encrypt the video files and require a valid decryption key, which is typically obtained through a secure handshake between the streaming server and the user's device.

End-to-End Encryption: markydoo.net will also offer end-to-end encryption, where the video content is encrypted on the server-side and remains encrypted until it is decrypted by the user's device. This provides an additional layer of security, especially when streaming sensitive or premium content.

By employing strong encryption mechanisms and protocols, markydoo.net will safeguard sensitive data and protect copyrighted content from unauthorized access or distribution.

1. Inventor claims that markydoo.net is the first authorized website to legally show screenings of films that are still in theatres.

2. Markydoo.net is the first film streaming platform to allow users the ability to pause, resume rewind and fast-forward previous scenes of the film within the interval that the film is streamed for a newly released film that is still in theatres.

3. Markydoo.net is the first to stream films at scheduled screening times.
